(19) United States
(12) Patent Application Publication
(10) Pub. No.: US 2010/0189845 A1
(43) Pub. Date: Jul. 29, 2010

(54) Flavor Encapsulation and Method Thereof

(75) Inventors: Julie Anne GROVER, Plano, TX (US); Kevin Arthur HEITFELD, Cincinnati, OH (US); James Dean OXLEY, San Antonio, TX (US); Joseph Thomas PERSYN, Lakehills, TX (US)

Correspondence Address: CARSTENS & CAHOON, LLP, P O BOX 802334, DALLAS, TX, 75380, US

(73) Assignee: FRITO-LAY NORTH AMERICA INC., Plano, TX (US)

(21) Appl. No.: 12/360,387

(22) Filed: Jan. 27, 2009

(51) Int. Cl. A23J 3/00; A23J 1/12; A23L 1/221; A23L 1/36

(52) U.S. Cl. 426/93; 426/436; 426/430; 426/650; 426/537

(57) ABSTRACT

A method for encapsulating flavoring with a prolamin. A prolamin, such as zein, is dissolved in an appropriate solvent. Flavoring is mixed with the prolamin solution. The prolamin and flavoring solution is dried, thereby forming a flavoring encapsulated by a prolamin.

### BACKGROUND OF THE INVENTION

1. Technical Field

The present invention relates to a method for the encapsulation of flavor using a natural ingredient to retain the flavor. In particular, the use of a prolamin such as zein to encapsulate flavor provides for a natural food alternative.

2. Description of Related Art

Flavors can be important in any food formula and can influence the finished product quality and cost. It is important to harness flavors and aromas to make products appealing to consumers for as long as possible after the product is initially produced. However, the complex systems associated with flavors are often difficult and expensive to control. For example, many flavorants contain top notes, such as dimethyl sulfide and acetaldehyde, which are quite volatile, vaporizing at or below room temperature. These top notes are often what give foods their fresh flavors. Because aroma and flavorings are usually delicate and volatile, their retention is a concern for food manufacturers. Manufacturing and storage processes, packaging materials and ingredients in foods often cause modifications in overall flavor by reducing aroma compound intensity or producing off-flavor components. In addition, once a product is on the store shelf, oxidation, hydrolysis, staling, and other processes may also cause it to lose its desired attributes and develop off-flavors.

To limit aroma degradation during processing and storage and retain aroma and flavor in a food product, it is beneficial to encapsulate the volatile flavor ingredients prior to use in foods or beverages. Different processes are used for encapsulation so as to impart some degree of protection against evaporation, reaction, or migration in a food. Encapsulation is the technique by which one material or a mixture of materials (known as active or core material) is coated with or entrapped within another material or system (referred to as shell, wall material, matrix, carrier or encapsulant). Encapsulation of flavors has been attempted and commercialized using many different methods, often dependent upon the end use of the product, the physical and chemical properties of the core material, the degree of stability required during storage and processing, the maximum obtainable flavor load, and the production cost. Further, many other factors such as the ratio of the core material flavor to wall material will affect the anti-oxidative stability of encapsulated flavor.

Spray drying is a commercial encapsulation process often used in the food and pharmaceutical industries. The process involves the dispersion of the substance to be encapsulated in a carrier material, which is typically a modified starch, as a suspension in water to form a slurry. The slurry is then fed into a hot chamber, where it is atomized to form small droplets and dried to a powder. This technology produces a very fine powder. Table 1 outlines the advantages and disadvantages of the spray-drying technique. Table 2 illustrates several of the different major materials currently used with spray drying techniques and their desired characteristics for encapsulating flavors. The materials listed are not an exhaustive list. Many encapsulations are actually composite formulations of any or all of the compounds listed.

TABLE 1
Advantages and Disadvantages of Spray-Drying.

| Advantages | Disadvantages |
|---|---|
| Low operating cost | Produce no uniform microcapsules |
| High quality of capsules in good | Limitation in the choice of wall material |
| yield | (low viscosity at relatively high |
| Rapid solubility of the capsules | concentrations) |
| Small size | Produce very fine powder which needs |
| High stability capsules | further processing |
| | Not good for heat-sensitive material |

TABLE 2
Wall materials typically used in flavor encapsulations.

| Wall Material | Characteristics |
|---|---|
| Maltodextrin (DE < 20) | Film forming |
| Corn syrup solid (DE > 20) | Film forming, reductability |
| Modified starch | Very good emulsifier |
| Gum Arabic | Emulsifier, film forming |
| Modified cellulose | Film forming |
| Gelatin | Emulsifier, film forming |
| Cyclodextrin | Encapsulant, emulsifier |
| Lecithin | Emulsifier |
| Whey protein | Good emulsifier |
| Hydrogenated fat | Barrier to oxygen and water |

In recent years, there has been a trend towards clean label formulations and labels. Some consumers desire products free of preservatives and artificial ingredients and prefer to consume products developed with natural ingredients. Prolamins are an example of a potential replacement for artificial ingredients presently used in the art. Prolamins are a group of plant storage proteins, high in proline content and found in the seeds of cereal grains. They are characterized by their solubilities in aqueous alcohol and by the fact that upon hydrolysis they yield a relatively large amount of amide nitrogen and proline, a cyclic, nonpolar amino acid. Gliadin is a prolamin protein from wheat, hordein is a prolamin protein from barley, secalin is a prolamin protein from rye, and zein is a prolamin protein from the maize kernel or corn.

Zein is one of the few cereal proteins extracted in a relatively pure form and is a natural, biodegradable polymeric material. Zein is an odorless, amorphous powder rich in branched amino acids. It constitutes 44-79% of the corn endosperm protein, depending on the corn variety and separation method used. The only known function of zein in nature is to act as storage for nitrogen in the developing seed of the maize kernel. Unlike most other commercially available proteins, it has unique thermoplastic and hydrophobic properties. It is highly resistant to water and grease, and unique in its ability to form odorless, tasteless, clear, tough films and fibers.

In light of the trend towards “clean label” foods and the complexities of flavorings, a need exists for a method of utilizing more natural compounds for encapsulating flavors to reduce artificial or modified ingredients. Moreover, there is a need to utilize natural proteins to protect sensitive materials such as flavors from degradation or loss. There is also a need for an encapsulation method that provides for the retention of costly flavoring ingredients without masking or dampening of flavoring, while providing high flavor loading and maintaining shelf-life.

### SUMMARY OF THE INVENTION

The present invention provides a method for the encapsulation of flavoring using at least one prolamin to reduce or eliminate the need for artificial or modified ingredients that are commonly used in encapsulations to protect flavorings from loss or degradation. The term “encapsulation” is used herein to mean both a process in which the whole surface of a matrix particle is covered with a coating composition containing at least one prolamin as well as partially covered or entrapped within a matrix of said composition.

At least one prolamin is dissolved in a food grade solvent, mixed with a flavoring and dried, forming an encapsulated powder of flavoring. The encapsulated flavoring can be applied to a food product to produce a product developed with natural ingredients. In one embodiment, at least one prolamin is dissolved in a solvent containing varying concentrations of ethanol and water of from between about 80%-90% ethanol and about 10-20% water. In one embodiment, between approximately 10% and approximately 40% of prolamin is added to the solvent. In another embodiment, between approximately 10% to approximately 20% of prolamin is added to the solvent. In one embodiment, flavor loading ranges from between approximately 15% to approximately 75%. In one embodiment, encapsulated flavorings have particle sizes of less than 50 microns. In another embodiment, encapsulated flavorings have particle sizes of less than 100 microns. Encapsulated flavorings comprise from approximately 25% to approximately 99.9 % zein and approximately 0.01% to approximately 75% flavor. In test runs, a zein prolamin was used to create a prolamin encapsulation of flavorings including lime, balsamic vinegar and Parmesan cheese.

Further objects and advantages of the present invention will be clear from the description that follows.

### DETAILED DESCRIPTION OF THE PREFERRED EMBODIMENTS

Flavoring foods involves complicated processing. In particular, natural flavors are often derived from more-expensive, and sometimes less-available, raw materials. A limited number of encapsulating methods exist but a wide range of different materials can be used, including proteins, carbohydrates, lipids, gums and cellulose. The choice of encapsulation materials depends upon a number of factors including: expected product objectives and requirements; nature of the core material; the process of encapsulation; and economics. In the present invention, a method for encapsulation of flavors with a prolamin provides a natural alternative for consumers, having little to no artificial or modified ingredients. Prolamins are seed storage proteins found in many cereal grains including without limitation maize, sorghum, millets, wheats, and ryes. They are known as such because they tend to have high levels of the amino acids proline and glutamine. The zein prolamin exists as mixtures of alpha, beta, delta, and gamma forms and is readily commercially available.

Zein is soluble in binary solvents exhibiting both polar and non-polar characteristics and containing a lower aliphatic alcohol and water, such as aqueous ethanol and aqueous isopropanol; however it is also soluble in a variety of other organic solvents. Tables 3, 4 and 5 list solvents for zein found in a zein review by John W. Lawton in the Cereal Chemistry Journal, Vol. 79, No. 1, 2002. Table 3 lists the primary solvents for zein, making at least a 10% (w/v) solution. The critical cloud points for each primary solvent are also listed, referring to the temperature at which dissolved solids are no longer completely soluble, precipitating as a second phase and giving the solution a cloudy appearance upon cooling. Emulsifiers can be added to stabilize the emulsion. While not all of the solvents listed in the following tables are food grade solvents, each is capable of dissolving the zein prolamin.

TABLE 3
Primary Solvents for Zein

| Solvent | Temp. ° C. |
|---|---|
| Acetamide | 82 |
| Acetic acid | 14 |
| 2-amino-2-ethyl-1,3-propandiol | 38 |
| 2-amino-2-methyl-1-propanol | 24 |
| Aniline | Gels |
| Benzyl alcohol | −18 |
| Benzyl Cellosolve | ≦40 |
| Butylamine | ≦40 |
| Butyl tartrate | ≦40 |
| 1,3-Butylene glycol | 39 |
| o-Cyclohexylphenol | >55 |
| 1,3-Diaminopropanol | 40 |
| Di [-βhydroxyethyl]aniline | >59 |
| Diethanolamine | 30 |
| Diethylene glycol | ≦40 |
| Diethylene glycol monoethyl ether | ≦40 |
| Diethylene glycol monomethyl ether | ≦40 |
| Diethylenetriamine | ≦40 |
| Diglycolchlorohydrine | ≦40 |
| Diisopropanolamine | 32 |
| Dipropylene glycol | ≦40 |
| Ethyl ether tripropylene glycol | −20 |
| Ethyl lactate | −24 |
| Ethylphenylethanolamine | −25 |
| Ethylene chlorohydrine | 40 |
| Ethylene glycol | 18 |
| Ethylene glycol monoethyl ether | ≦40 |
| Ethylene glycol monomethyl ether | ≦40 |
| Ethylenediamine | 11 |
| Formic acid | 7 |
| Furfuryl alcohol | ≦40 |
| Glycerol | 139 |
| Glycerol furfuryl | ≦40 |
| Glycerol-α-γ-dimethyl ether | ≦40 |
| Glycerol-α-monochlorohydrine | ≦40 |
| Glycerol-α-methyl ether | ≦40 |
| Glycerol-α-phenyl ether | >54 |
| β-Hydroxyethyl aniline | −30 |
| Hydroxyethylethylenediamine | ≦40 |
| 2-Hydroxymethyl-1,3-dioxolane | ≦40 |
| Lactic acid | ≦40 |
| Methanol | 63 |
| Methyl lactate | ≦40 |
| Monoethanolamine | 6 |
| Monoisopropanolamine | −4 |
| Morpholine | −6 |
| Morpholine ethanol | >2 |
| Phenol | 40 |
| Phenylethanolamine | −15 |
| Propionic acid | 60 |
| Propylene chlorohydrin | −30 |
| Propylenediamine | ≦40 |
| Propylene glycol | ≦40 |
| Pyridine | ≦40 |
| Resoricinol monoaceate | 0 |
| Triethanolamine | >21 |
| Triethylenetetramine | ≦40 |
| Tetrahydrofurfury I alcohol | ≦40 |
| Triethylene glycol | ≦40 |
| Triisopropanolamine | >46 |

All the primary solvents are glycols, glycol-ethers, amino-alcohols, nitro-alcohols acids, amides, or amines. For a single substance to be a good solvent for zein, the molecule needs to have the proper balance between polar and nonpolar groups. Water as well as aromatic hydrocarbons are also said to improve the solvent power of anhydrous alcohols. Ketone and water mixtures can also make good binary solvents.

The solvating power of binary solvents depends on the ratio of the two components. Table 4 lists the solubility of zein in binary solvent systems where lower aliphatic alcohols, ketones, or glycols are the primary component and water, aromatic hydrocarbons, chlorinated hydrocarbons, nitroparafins, aldehydes, or cyclic ethers are the secondary components. In addition to the aqueous alcohols, aqueous solutions of acetone, isopropanol, and isobutanol are also effective solvents for zein.

TABLE 4
Secondary Solvents for Zein

| Water in combination with | A lower aliphatic alcohol |
|---|---|
| one of the following | and one of the following |
| Acetone | Acetaldehyde |
| Acetonyl acetone | Acetone |
| n-Butanol | Benzene |
| t-Butanol | Butyl lactate |
| s-Butanol | Chloroform |
| Dioxalane | Dichloromethane |
| Dioxane | Diethylene glycol monoethyl ether |
| Ethanol | Ethyl lactate |
| Isobutanol | Ethylene dichloride |
| Isopropanol | Ethylene glycol |
| Methanol | Ethylene glycol monoethyl ether |
| n-Propanol | Furfural |
| | Methyl ethyl ketone |
| | Methylene chloride |
| | Nitroethane |
| | Nitromethane |
| | Propylene glycol |
| | 1,1,2,2-Tetrachloroethane |
| | 1,2,3-Trichloroethane |
| | Toluene |

Ternary solvent mixtures utilizing water in addition to alcohol and aldehyde mixtures can also be used to dissolve zein. Table 5 lists the ternary solvents for zein.

TABLE 5
Ternary Solvents for Zein
Water, a lower aliphatic alcohol, and one of the following

| | |
|---|---|
| Acetaldehyde | Dioxane |
| Acetone | Ethylene glycol monoethyl ether |
| Acetonylacetone | Formaldehyde |
| Benzene | Methyl acetate |
| Butyradehyde | Nitroethane |
| Diacetone alcohol | Nitromethane |

Water and any two of the following

| | |
|---|---|
| 1,3-Butanediol | Dipropylene glycol |
| 1,4-Butanediol | Ethylene glycol |
| 2,3-Butanediol | Hexylene glycol |
| Diethylene glycol | Propylene glycol |

One embodiment of the present invention will now be described. A prolamin is dissolved in a solvent capable of dissolving a prolamin, forming a prolamin solution. As discussed above, Tables 3-5 list a number of solvents capable of dissolving a prolamin such as zein. It should be noted that solvents with higher boiling points such as glycols require higher temperatures for removal, which may result in increased flavor loss. For use with the present invention, it is preferable to use food grade solvents that allow for the production of edible encapsulated flavorings including without limitation water, ethanol, propanol, butanol, isopropanol, isobutanol, acetic acid, lactic acid, acetone, ethyl acetate, benzyl alcohol, and any mixtures thereof. As used herein, the term “food grade” means that up to specified amounts of the particular compound can be ingested by a human without generally causing deleterious health effects. Examples of food grade compounds include those compounds “generally recognized as safe” (“GRAS”) by the United States Food and Drug Administration (“FDA”), including those listed under 21 C.F.R. §§172, 182 and 184.

The dissolving of the prolamin is meant to encompass dispersing to form a solution, dispersion, or emulsion comprising a prolamin. Viscosity causes fluids to resist agitation, preventing its breakup and leading to larger particle sizes. Thus, the viscosity of a solution will affect the characteristics of the end product flavor encapsulations of the present invention. By way of example and without intending to limit the scope of the present invention, viscosity measurements for various prolamin solutions that were used with the present invention are shown in Table 6 below. Non-genetically modified zein refers to zein whose genetic material has not been altered using genetic engineering techniques.

TABLE 6
Viscosity Measurements for Various Zein Prolamin Solutions

| | | Viscosity (cP) |
|---|---|---|
| Prolamin | Solvent | @ room temp |
| 10% Zein | 90:10 EtOH:water | 11.7 |
| | 80:20 EtOH:water | 11.1 |
| | 50:50 EtOH:water | 4.5 |
| 15% Zein | 90:10 EtOH:water | 21.3 |
| | 80:20 EtOH:water | 57.9 |
| | 50:50 EtOH:water | 4.5 |
| 10% Zein non-GMO | 90:10 EtOH:water | 16.5 |
| | 80:20 EtOH:water | 68.4 |
| | 50:50 EtOH:water | 4.5 |
| 10% Zein | 90:10 IPA:water | 14.7 |
| | 80:20 IPA:water | >120 |
| 10% Zein | 100% Benzyl alcohol | 47.7 |

Table 6, above, lists various prolamin solutions used with the present invention and their measured viscosities. Results may vary due to the processing conditions and the quality of the prolamin used. In one embodiment, the viscosity of the prolamin solution used is greater than approximately 4.0 centipoise (cP). In another embodiment, the viscosity of the prolamin solution ranges from approximately 4 cP to approximately 120 cP.

In an embodiment using 10% zein dissolved in a 90:10 solution of ethanol:water, the resulting viscosity ranges from between approximately 11.5 to approximately 11.9 cP, and more preferably approximately 11.7 cP. In another embodiment using 10% zein in an 80:20 ethanol:water solution, the prolamin solution comprises a viscosity of approximately 10.9 cP to approximately 11.3 cP, and more preferably approximately 11.1 cP. In an embodiment prepared with 15% zein in a solution of 90:10 ethanol:water, the viscosity falls within approximately 21.1 cP to approximately 21.5 cP, and more preferably approximately 21.3 cP. In another embodiment using 15% zein in a 80:20 solution of ethanol:water, the prolamin solution comprises a viscosity of approximately 57.7 cP to approximately 61.1 cP, and more preferably approximately 57.9 cP. In an alternate embodiment, a 50:50 solution of ethanol:water results in a viscosity of approximately 4.5 cP. In this embodiment, centrifugation was necessary to separate out undissolved zein, resulting in lower zein concentrations. As the zein load decreased, the effective zein concentration decreased. For example, 10% zein dissolved in 50:50 ethanol:water resulted in a concentration of less than 2.5% zein, while 15% zein dissolved in the same solution resulted in less than 3.9% zein. Non-genetically modified 10% zein resulted in less than 1.1% zein concentration in the same solution. However, using different drying methods, a batch amount of encapsulated flavor can be achieved using the methods described as follows.

Once the prolamin is dissolved, flavoring is added to the prolamin solution and mixed by mechanical stirring under high shear. By “high shear” it is meant that that the solution is blended or mixed mechanically under high speed to thoroughly disperse or dissolve the flavor throughout the prolamin solution. As used herein, the term “flavors” is synonymous with “flavorings” and refers to flavor ingredients including but not limited to extracts, essential oils, essences, distillates, resins, balsams, juices, botanical extracts, flavor, fragrance, and aroma ingredients including essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof as well as any substance having a function of imparting flavor and/or aroma. In test runs, lime, balsamic vinegar and Parmesan cheese flavorings were encapsulated as discussed in the examples below. However, one skilled in the art, armed with this disclosure, will recognize that any number of flavorings in general can be used with the present invention. Encapsulates were produced containing flavor levels as high as 75% after drying.

The mixed flavoring and prolamin solution is dried to form particles. Any number of suitable drying methods exists. By way of example, drying methods include spinning disk atomization as well as other spray drying techniques such as atomization by nozzle or rotary atomizer. Processing conditions such as drying can vary depending on a number of factors, including the viscosity, surface tension and density of the sample. Spinning disk atomization produces high quality powders in the form of narrowly dispersed or monosized spherical beads, in the size range of approximately 5 to 100 μm.

During spinning disk atomization, a nozzle introduces fluid at the center of a spinning disk. Centrifugal force carries the fluid to and throws the fluid off the edge of the disk. The liquid breaks down into fine droplets or microparticles, which are formed by the removal of the solvent and collected using a cyclone separator, a centrifugal separator where the particles are swung as a result of their mass by the centrifugal force to the outside. Entering air automatically forces a rapidly spinning double vortex movement, called a “double-vortex”. This double vortex movement exists from the outside stream that flows spirally down and the inside stream that flows spirally up. On the border area of both flows, the air flows from one to the other. The particles present in the air flow are swung to the outside wall and leave the separator by means of a reception space situated to the base. In the examples below, a 3-inch disk was used for the atomization at a disk speed of about 8,500 rpm or about 10,000 rpm, a feed rate of between about 53 to about 65 g/min and an outlet temp of about 50-55° C. As a result, a powder of flavoring encapsulated within a prolamin matrix is achieved.

The invention will now be further elucidated with reference to the following examples, which should be understood to be non-limitative. Tables 7, 8 and 9, below, illustrate the encapsulations of a lime, Parmesan cheese, and Balsamic vinegar flavoring, respectively, using a mixture of ethanol and water in a proportion of 90:10 as the prolamin solvent. One skilled in the art would recognize that these and other flavorings are readily commercially available from any number of manufacturers.

TABLE 7
Lime flavoring zein encapsulates.

| | Prolamin | | Tem- | Disk | | | |
|---|---|---|---|---|---|---|---|
| | Concen- | Flavor | perature | speed | Size (microns) | | |
| Example | tration | Loading | (° C.) | (rpm) | 10% | 50% | 90% |
| 1 | 10% | 15% | 51 | 8,000 | 20 | 42 | 77 |
| 2 | 10% | 55% | 51 | 8,000 | 21 | 41 | 76 |
| 3 | 10% | 75% | 51 | 8,000 | 24 | 54 | 108 |
| 4 | 10% | 55% | 48 | 10,000 | 12 | 25 | 49 |
| 5 | 10% | 55% | 45 | 10,000 | 12 | 26 | 53 |
| 6 | 10% | 55% | 41 | 10,000 | 12 | 27 | 53 |
| 7 | 12.5% | 55% | 50 | 10,000 | 11 | 25 | 52 |
| 8 | 15% | 55% | 50 | 10,000 | 13 | 33 | 66 |

In example one of Table 7, 180 grams of a solution of 90% Ethanol and 10% water by weight was prepared and 20 grams of zein was added and dissolved to form the 10% zein solution. A load of lime oil flavoring was added to the zein solution such that the theoretical loading after drying would be 15%. Approximately 3.53 grams of lime oil was added to the zein solution to create the 15% load of lime, calculated based on 3.53 grams of lime oil divided by total of the amount of zein and flavoring added (in this example, 3.53/[20+3.53]=0.15). Consequently, “flavor loading” is calculated herein by the following formula: (amount of flavor)/(amount of flavor+amount of solids added). Returning to example one of Table 7, following the addition of flavoring, the flavoring and prolamin solution was then mixed under high shear. The mixed solution was then dried using the spinning disk atomization method wherein a 3-inch disk was used at a disk speed of about 8,000 rpm with a feed rate of about 62 g/min and at an outlet temp of about 51° C. Approximately 14.28 grams of product was collected in the cyclone separator (a 61% yield). The resulting dried powder particles had a particle size distribution of approximately 1 to 120 microns, with an average particle size of approximately 42 microns, where 10% of the measure sample was less than 20 microns, 50% was less than 42 microns and 90% was less than 77 microns.

TABLE 8
Parmesan cheese flavoring zein encapsulates using a 10% zein solution.

| | Flavor | Temperature | Disk speed | Size (microns) | | |
|---|---|---|---|---|---|---|
| Example | Loading | (° C.) | (rpm) | 10% | 50% | 90% |
| 9 | .15% | 51 | 8,000 | 27 | 49 | 87 |
| 10 | 55% | 51 | 8,000 | 34 | 58 | 98 |
| 11 | 75% | 51 | 8,000 | 46 | 75 | 120 |
| 12 | 75% | 51 | 10,000 | 30 | 47 | 76 |
| 13 | 55% | 51 | 10,000 | 23 | 37 | 62 |

In Table 8, the examples were prepared in the same way as the examples of Table 7, using a 10% zein solution. By way of example and without limiting the scope of the invention, in example 10 of Table 8, 180 grams of a solution of 90% Ethanol and 10% water by weight was prepared and 20 grams of zein was added and dissolved to form the 10% zein solution. A load of Parmesan cheese flavoring was added to the zein solution such that the theoretical loading after drying would be 55%. Approximately 24.4 grams of Parmesan cheese flavoring was added to the zein solution to create the 55% load of Parmesan cheese, calculated based on 24.4 grams of Parmesan cheese divided by total of the amount of zein and flavoring added (in this example, 24.4/[20+24.4] is about 0.55). The flavoring and prolamin solution was then mixed under high shear to form a mixed solution. The mixed solution was then dried using the spinning disk atomization method wherein a 3-inch disk was used at a disk speed of about 8,000 rpm with a feed rate of about 76/min and at an outlet temp of about 51° C. Approximately 29 grams of product was collected in the cyclone separator. The resulting dried powder particles had a particle size distribution of approximately 20 to 160 microns, where 10% of the measure sample was less than 34 microns, 50% was less than 58 microns and 90% was less than 98 microns.

TABLE 9
Balsamic flavoring zein encapsulates using a 10% zein solution.

| | Flavor | Temperature | Disk speed | Size (microns) | | |
|---|---|---|---|---|---|---|
| Example | Loading | (° C.) | (rpm) | 10% | 50% | 90% |
| 14 | 15% | 51 | 8,000 | 21 | 45 | 90 |
| 15 | 55% | 51 | 8,000 | 20 | 40 | 81 |
| 16 | 75% | 51 | 8,000 | 36 | 59 | 100 |

The examples of Table 9 were prepared in the same way as the above examples of Tables 7 and 8. By way of example and without intending to limit the scope of the invention, in example 16 of Table 9, 90 grams of a solution of 90% Ethanol and 10% water by weight was prepared and 10 grams of zein was added and dissolved to form the 10% zein solution. A load of balsamic flavoring was added to the zein solution such that the theoretical loading after drying would be 75%. Approximately 30 grams of balsamic flavoring was added to the zein solution to create the 75% load of balsamic, calculated based on 30 grams of balsamic divided by total of the amount of zein and flavoring added (in this example, 30/[10+30]=0.75). The flavoring and prolamin solution was then mixed under high shear to form a mixed solution. The mixed solution was then dried using the spinning disk atomization method wherein a 3-inch disk was used at a disk speed of about 8,000 rpm with a feed rate of about 52 g/min and at an outlet temp of about 51° C. Approximately 4.65 grams of product was collected in the cyclone separator. The resulting dried powder particles had a particle size distribution of approximately 22 to 210 microns (μm), where 10% of the measure sample was less than 36 microns, 50% was less than 59 microns and 90% was less than 100 microns.

Although the above examples provide specifics values for the concentration levels of ethanol and water, the levels of zein, ethanol, and water can be varied. By way of example and without intending to limit the scope of the invention, as seen in Table 6, 80:20 proportions of ethanol and water can also be used to dissolve the prolamin. In one test run, 360 grams of a solution of 80% Ethanol and 20% water by weight was prepared and 40 grams of zein was added and dissolved to form the 10% zein solution. A load of lime oil was added to the zein solution such that the theoretical loading after drying would be 55%. Approximately 48.8 grams of lime oil was added to the zein solution to create the 55% load of Imne oil, calculated as above (based on 48.8 grams of lime flavor divided by total of the amount of zein and flavoring added (88.8 grams) for an approximate 0.55 or 55%). The flavoring and prolamin solution was then mixed under high shear to form a mixed solution. The mixed solution was then dried using the spinning disk atomization method wherein a 3-inch disk was used at a disk speed of about 8,000 rpm and at an outlet temp of about 51° C. The resulting dried powder particles had a particle size distribution of approximately 1 to 120 microns (μm) where 10% of the measure sample was less than 12 microns, 50% was less than 27 microns and 90% was less than 57 microns.

Other ingredients common to encapsulating flavors can also be incorporated, including without limitation carbohydrates, hydrocolloids, gums, emulsifiers, calcium silicate, silicon dioxide, and cellulose materials such as ethyl cellulose, and hydroxypropyl cellulose. While the invention has been particularly shown and described with reference to particular embodiments, it will be understood by those skilled in the art that various changes in form and detail may be made therein without departing from the spirit and scope of the invention.

What is claimed is:

1. A method for encapsulating flavor comprising the steps of:
dissolving at least one prolamin in a solvent, thereby forming a prolamin solution;
mixing a flavoring with said prolamin solution; and
drying said mixed solution, thereby forming a prolamin-encapsulated flavoring.

2. The method of claim 1, wherein said solvent is a binary solvent of ethanol and water.

3. The method of claim 2, wherein said binary solvent is approximately a 90:10 mixture of ethanol:water.

4. The method of claim 1, wherein the prolamin solution comprises a viscosity of at least approximately 4.0 cP.

5. The method of claim 2, wherein said binary solvent is approximately an 80:20 mixture of ethanol:water.

6. The method of claim 1, wherein the solvent is chosen from the group consisting of:
water, ethanol, propanol, butanol, isopropanol, isobutanol, acetic acid, lactic acid, acetone, ethyl acetate, benzyl alcohol, and any mixtures thereof.

7. The method of claim 1, wherein the at least one prolamin comprises zein.

8. The method of claim 1, wherein said prolamin solution further comprises a 10% zein solution.

9. The method of claim 1, wherein said prolamin-encapsulated flavoring comprises up to about 75% by weight flavoring.

10. The method of claim 1, wherein said flavoring is chosen from the group consisting of lime, Parmesan cheese and balsamic vinegar.

11. The method of claim 1, wherein said mixing step is done under high shear.

12. The method of claim 1, wherein said drying step is performed using a spinning disk atomization method.

13. The method of claim 1, wherein said drying step further comprises the formation of said encapsulated flavorings having particle sizes of less than 50 microns.

14. The method of claim 1, wherein said prolamin-encapsulated flavoring comprise particle sizes of less than 100 microns.

15. The method of claim 1, wherein said prolamin-encapsulated flavoring comprise a particle size distribution of approximately 1 to approximately 250 microns.

16. The prolamin-encapsulated flavoring produced by the method of claim 1.

17. A flavoring encapsulated by at least one prolamin, wherein said at least one prolamin is present in an amount of between approximately 25% to 99.9% by weight.

18. The flavoring of claim 17, wherein said at least one prolamin comprises zein.

19. The flavoring of claim 17, wherein said encapsulated flavoring comprises a particle size distribution of approximately 1 to approximately 250 microns.

20. The flavoring of claim 17, wherein said encapsulated flavoring has a particle size of less than approximately 50 microns.

21. The flavoring of claim 17, wherein said encapsulated flavoring has a particle size of less than approximately 100 microns.

22. The flavoring of claim 17, wherein said flavoring is selected from the group consisting of lime oil, Parmesan cheese, and balsamic vinegar.
